(19) United States
(12) Patent Application Publication
(10) Pub. No.: US 2025/0333862 A1
(43) Pub. Date: Oct. 30, 2025

(54) SOLID OXIDE ELECTROLYSIS CELL AND METHOD OF MANUFACTURING THE SAME

(71) Applicants: HYUNDAI MOTOR COMPANY, SEOUL (KR); KIA CORPORATION, SEOUL (KR); UIF (UNIVERSITY INDUSTRY FOUNDATION), YONSEI UNIVERSITY, SEOUL (KR); KOREA INSTITUTE OF SCIENCE AND TECHNOLOGY, SEOUL (KR)

(72) Inventors: Ji Wan Kim, Uiwang-si (KR); Ji Hoon Jang, Yongin-si (KR); Si Won Kim, Uijeongbu-si (KR); Shin Tae Bae, Incheon (KR); Hwi Tae Kim, Gwangmyeong-si (KR); Jong Sup Hong, Seoul (KR); Kyung Joong Yoon, Seoul (KR)

(73) Assignees: HYUNDAI MOTOR COMPANY, SEOUL (KR); KIA CORPORATION, SEOUL (KR); UIF (UNIVERSITY INDUSTRY FOUNDATION), YONSEI UNIVERSITY, SEOUL (KR); KOREA INSTITUTE OF SCIENCE AND TECHNOLOGY, SEOUL (KR)

(21) Appl. No.: 18/756,646

(22) Filed: Jun. 27, 2024

(30) Foreign Application Priority Data
Apr. 25, 2024 (KR) 10-2024-0055204

(51) Int. Cl. C25B 11/031; C25B 1/04; C25B 11/069; C25B 11/077; C25B 11/091

(52) U.S. Cl. CPC C25B 11/031; C25B 1/04; C25B 11/069; C25B 11/0773; C25B 11/091

(57) ABSTRACT

A solid oxide electrolysis cell includes an oxygen electrode, a fuel electrode, and an electrolyte interposed between the oxygen electrode and the fuel electrode. The oxygen electrode comprises an oxygen electrode carrier comprising internal pores, and an oxygen electrode catalyst supported in the internal pores, and having a perovskite single-phase structure. The fuel electrode comprises a fuel electrode carrier and a fuel electrode catalyst supported on the fuel electrode carrier.

### CROSS REFERENCE TO RELATED APPLICATIONS

This application claims, under 35 U.S.C. § 119(a) the benefit of priority to Korean Patent Application No. 10-2024-0055204, filed on 25 Apr. 2024, the entire contents of which are incorporated herein by reference.

### BACKGROUND

### (a) Technical Field

The present disclosure relates to a solid oxide electrolysis cell and a method of manufacturing the same.

### (b) Background Art

Hydrogen is eco-friendly energy that can be produced using water. Demand for technology to produce hydrogen continues to grow and the importance thereof is increasing every year. There are various methods for producing hydrogen, including water decomposition through electrolysis and photocatalytic hydrogen production. Thereamong, a solid oxide electrolysis cell (SOEC) is a highly efficient water electrolysis technology.

A solid oxide electrolysis cell includes an electrolyte, a fuel electrode, and an oxygen electrode. Water vapor decomposes at the fuel electrode to produce hydrogen, and oxygen ions generated in this process pass through the electrolyte and move to the oxygen electrode. At the oxygen electrode, oxygen ions are converted into oxygen molecules.

Solid oxide electrolysis cells may be divided into oxygen electrode-supported cells and electrolyte-supported cells. The electrolyte-supported cells usually operate at 800° C. or higher. As the operating temperature increases, the current density increases. However, high operating temperatures increase the consumption of electrical energy, affect durability, and shorten the lifespan of the cells.

The oxygen electrode-supported cell operates at a lower temperature of 650° C. to 700° C. It is important to develop methods for producing hydrogen even at low temperatures and to conduct research on methods for reducing the energy required for operation and producing hydrogen with high efficiency.

Meanwhile, oxygen ions generated during the process of producing hydrogen in a solid oxide electrolysis cell receive electrons from the oxygen electrode and are converted into oxygen. During long-term operation of a solid oxide electrolysis cell, oxygen ions may accumulate at the interface between the electrolyte and the oxygen electrode, causing interfacial peeling. Therefore, it is important to develop materials for the oxygen electrode to improve the interfacial stability between the electrolyte and the oxygen electrode, and electrode efficiency and the like.

In addition, currently developed solid oxide electrolysis cells utilize components of conventional solid oxide fuel cells and have problems of insufficient performance and reduced durability due to the absence of dedicated materials. In particular, conventional nickel-YSZ (Yttria stabilized zirconia)-based fuel electrodes have a problem of greatly reduced stability due to the deterioration of nickel.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art and it is one object of the present disclosure to provide a solid oxide electrolysis cell with high interfacial stability between an oxygen electrode and an electrolyte, and a method of manufacturing the same.

It is another object of the present disclosure to provide a solid oxide electrolysis cell with improved high-temperature water electrolysis efficiency and a method of manufacturing the same.

It is another object of the present disclosure to provide a solid oxide electrolysis cell with improved durability and a method of manufacturing the same.

The objects of the present disclosure are not limited to those described above. Other objects of the present disclosure will be clearly understood from the following description, and are able to be implemented by means defined in the claims and combinations thereof.

In one aspect, the present disclosure provides a solid oxide electrolysis cell including an oxygen electrode, a fuel electrode, and an electrolyte interposed between the oxygen electrode and the fuel electrode.

The oxygen electrode may include an oxygen electrode carrier including internal pores and an oxygen electrode catalyst supported in the internal pores, and the oxygen electrode catalyst may have a perovskite single-phase structure.

The fuel electrode may include a fuel electrode carrier and a fuel electrode catalyst supported on the fuel electrode carrier.

The fuel electrode carrier may include first particles containing nickel (Ni) and second particles containing yttria-stabilized zirconia (YSZ).

The fuel electrode catalyst may include a first component containing at least one selected from the group consisting of iron (Fe), cobalt (Co), palladium (Pd), copper (Cu), molybdenum (Mo), and combinations thereof, and a second component containing gadolinia-doped ceria (GDC).

At least a part of the first component may form an alloy with the first particles on the surface of the first particles.

The oxygen electrode carrier may include at least one of compounds represented by Formulas 1 to 4 below:

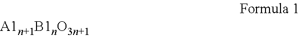

wherein A1 includes La, Nd, Pr, or Ga,
B1 includes Ni, Co, or Cu, and
n satisfies 1≤n≤3.

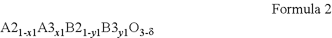

wherein
A2 includes La, Ba or Y,
A3 includes Sr or Ca,
B2 and B3 are different from each other and each include Mn, Co, Fe or Ni, and
x, y and δ satisfy 0<x1<1, 0<y1<1 and 0≤δ≤1, respectively.

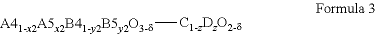

wherein
A4 includes La, Ba or Y,
A5 includes Sr or Ca,
B4 and B5 are different from each other and each include Mn, Co, Fe or Ni,
C includes Y, Sc, Gd, Sm or Ca,
D includes Zr or Ce, and
X2, y2, z and δ satisfy 0<x2<1, 0<y2<1, 0<z<1, and 0≤δ≤1, respectively.

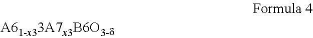

wherein
A6 includes La, Ba or Y,
A7 includes Sr or Ca,
B6 includes Mn, Co, Fe or Ni, and
x3 and δ satisfy 0<x3<1 and 0≤δ≤1, respectively.

The oxygen electrode carrier may include a compound represented by Formula 5 below:

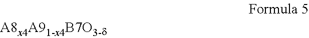

A8 and A9 are different from each other and include Sm, Sr, La, Ca or Ba, respectively,
B7 includes Co, Mn or Fe, and
X4 and δ satisfy 0<x4<1 and 0≤δ≤1, respectively.

The oxygen electrode catalyst may have an average diameter of 20 nm to 30 nm.

The first particles may have a size of 1.5 μm or less, and the second particles may have a size of 350 nm to 500 nm.

The fuel electrode catalyst may have a size of 20 nm to 60 nm.

In another aspect, the present disclosure provides a method of manufacturing a solid oxide electrolysis cell including producing an oxygen electrode, producing a fuel electrode, and producing a stack including the oxygen electrode, the fuel electrode, and an electrolyte located between the oxygen electrode and the fuel electrode.

The producing the oxygen electrode may include dissolving a precursor of the oxygen electrode catalyst, urea and glycine in a solvent to prepare a reactant containing a cation derived from the precursor of the oxygen electrode catalyst, adding the reactant to an oxygen electrode carrier to obtain an intermediate, and heat-treating the intermediate to support the oxygen electrode catalyst in the internal pores of the oxygen electrode carrier.

The solvent may include alcohol and water in a volume ratio of 0.1:1 to 2:1.

The cation derived from the precursor of the oxygen electrode catalyst may include at least one selected from the group consisting of Sm, Sr, La, Ca, Ba, Co, Mn, Fe, and combinations thereof.

The reactant may include the urea and the cation at a molar ratio of 5:1 to 15:1 and the reactant may include the glycine and the cation at a molar ratio of 0.5:1 to 5:1.

The producing the fuel electrode may include preparing a fuel electrode carrier including the first particles and the second particles, adding, to the fuel electrode carrier, a first solution containing a precursor of the first component, a complexing agent, and a mixed solvent of an aqueous solvent and an alcohol-based solvent, and performing primary heat treatment to obtain a first intermediate, adding, to the first intermediate, a second solution containing a precursor of the second component, a complexing agent, and a mixed solvent of an aqueous solvent and an alcohol-based solvent, and performing secondary heat treatment to obtain a second intermediate, and reducing the second intermediate under a hydrogen atmosphere to form a fuel electrode.

A molar ratio of the cation of the precursor of the first component to the complexing agent in the first solution may be 1 to 10 and a molar ratio of the cation of the precursor of the second component to the complexing agent in the second solution may be 1 to 10.

The complexing agent may include at least one selected from the group consisting of urea, glycine, Triton-X, citric acid, and combinations thereof.

The precursor of the first component may be added in an amount of 2.25 mg/cm² to 2.75 mg/cm².

The primary heat treatment may include heating the reaction product at 50° C. to 100° C. for 1 hour to 3 hours, heating the reaction product at 120° C. to 200° C. for 1 hour to 2 hours, and heating the reaction product at 300° C. to 500° C. for 1 hour to 3 hours, and the primary heat treatment may be repeated one or more times.

The precursor of the second component may be added in an amount of 81 mg/cm² to 87 mg/cm².

The secondary heat treatment may include heating the reaction product at 50° C. to 100° C. for 1 hour to 3 hours, heating the reaction product at 120° C. to 200° C. for 1 hour to 2 hours, and heating the reaction product at 300° C. to 500° C. for 1 hour to 3 hours, and the secondary heat treatment is repeated one or more times.

### BRIEF DESCRIPTION OF THE FIGURES

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 illustrates a solid oxide electrolysis cell according to the present disclosure;

FIG. 2 illustrates the configuration of a fuel electrode carrier according to the present disclosure;

FIG. 3 illustrates the configuration of a fuel electrode according to the present disclosure;

FIG. 4 illustrates the results of Fourier-transform infrared spectroscopy (FT-IR) when urea is bonded to metal cations;

FIG. 5 illustrates the results of Fourier transform infrared spectroscopy analysis when glycine is bonded to metal cations;

FIG. 6 illustrates the results of X-ray diffraction (XRD) analysis of the oxygen electrode catalysts according to Preparation Example 1 and Comparative Preparation Example 1;

FIG. 7 illustrates the result of X-ray diffraction analysis of the oxygen electrode catalyst according to Comparative Preparation Example 2;

FIG. 8 illustrates the results of Fourier transform infrared spectroscopy analysis of oxygen electrode catalysts according to Preparation Example 1 and Comparative Preparation Example 1;

FIG. 9 illustrates the results of thermogravimetric analysis (TGA) for oxygen electrode catalysts according to Preparation Example 1 and Comparative Preparation Example 1;

FIG. 10 illustrates the results of scanning electron microscope (SEM) analysis of the oxygen electrode for a solid oxide electrolysis cell according to Comparative Example 2;

FIG. 11 illustrates the result of scanning electron microscopy analysis of the oxygen electrode for a solid oxide electrolysis cell according to Example 1;

FIG. 12 illustrates the results of sintering the oxygen electrode for a solid oxide electrolysis cell according to Example 1 at about 650° C. for about 100 hours and analyzing the result using a scanning electron microscope;

FIG. 13 illustrates the result of sintering the oxygen electrode for a solid oxide electrolysis cell according to Comparative Example 1 at about 650° C. for about 100 hours and analyzing the result using a scanning electron microscope;

FIG. 14 illustrates the result of observing the oxygen electrode for a solid oxide electrolysis cell according to Example 1 using a transmission electron microscope;

FIG. 15 illustrates the result of observing the oxygen electrode for a solid oxide electrolysis cell according to Comparative Example 1 using a transmission electron microscope;

FIG. 16 illustrates the result of measuring the electrochemical performance of the solid oxide electrolysis cell according to Example 1;

FIG. 17 illustrates the results of measuring the electrochemical performance of the solid oxide electrolysis cell according to Comparative Example 1;

FIG. 18 illustrates the polarization resistance of the solid oxide electrolysis cells according to Example 1 and Comparative Example 1;

FIG. 19 illustrates the measurement of the deterioration rate of the solid oxide electrolysis cell according to Example 2;

FIG. 20 illustrates the result of analyzing the solid oxide electrolysis cell according to Example 2 using a scanning electron microscope before evaluating the deterioration rate;

FIG. 21 illustrates the result of analyzing the solid oxide electrolysis cell according to Example 2 using a scanning electron microscope after evaluating the deterioration rate;

FIG. 22 illustrates the result of analyzing the fuel electrode according to Preparation Example 2 using a scanning electron microscope (SEM);

FIG. 23 illustrates polarization resistance of Preparation Example 2 (Fe-GDC), Preparation Example 3 (Co-GDC), Comparative Preparation Example 3 (Reference), and Comparative Preparation Example 4 (GDC);

FIG. 24A illustrates the durability of the fuel electrodes according to Comparative Preparation Example 3 (Reference);

FIG. 24B illustrates the durability of the fuel electrodes according to Comparative Preparation Example 6 (Fe);

FIG. 24C illustrates the durability of the fuel electrodes according to Comparative Preparation Example 4 (GDC);

FIG. 24D illustrates the durability of the fuel electrodes according to Preparation Example 2 (Fe-GDC); and

FIG. 25 illustrates the performance of the fuel electrodes according to Preparation Example 2 (Fe-GDC), Comparative Preparation Example 3 (Reference), Comparative Preparation Example 4 (GDC), and Comparative Preparation Example 6 (Fe).

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed contents and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined.

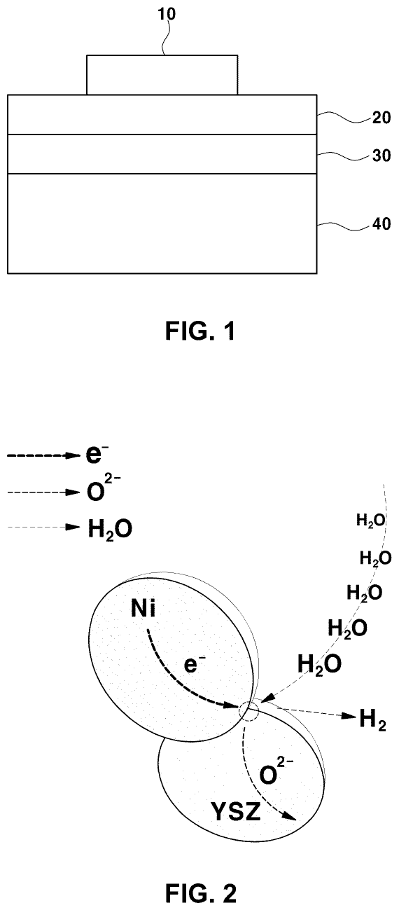

FIG. 1 illustrates a solid oxide electrolysis cell according to the present disclosure. The solid oxide electrolysis cell may be a stack including an oxygen electrode 10, an electrolyte 30, a fuel electrode 20, and a fuel electrode support layer 40.

Water vapor flows into the fuel channel and decomposes when voltage is applied to the fuel electrode 20. The half reaction and full reaction of the fuel electrode 20 and the oxygen electrode 10 are as follows.
Fuel electrode: H₂O+2e⁻→H₂+O²⁻
Oxygen electrode: O²⁻→1/2O₂+2e⁻
Overall reaction: H₂O→H₂+1/2O₂

The oxygen electrode 10 may include an oxygen electrode carrier including internal pores and an oxygen electrode catalyst supported in the internal pores.

The oxygen electrode carrier may have a three-dimensional plate or membrane shape having at least two opposite main surfaces. The two main surfaces may each have a predetermined curved surface in addition to a mathematical plane, or may have irregularities generated during formation of the oxygen electrode carrier. In this regard, the shape of the oxygen electrode carrier is not limited to a relatively thin rectangular parallelepiped.

The thickness of the oxygen electrode carrier is not particularly limited. The thickness of the oxygen electrode carrier may refer to the gap between the two opposing main surfaces.

The oxygen electrode carrier may include internal pores. The internal pores may be closed pores or open pores.

The oxygen electrode carrier may contain at least one of the compounds represented by Formulas 1 to 4 below:

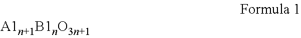

wherein A1 includes La, Nd, Pr, or Ga,
B1 includes Ni, Co, or Cu, and
n satisfies 1≤n≤3.

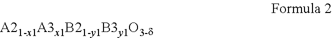

wherein
A2 includes La, Ba or Y;
A3 includes Sr or Ca;
B2 and B3 are different from each other and each include Mn, Co, Fe or Ni, and
x, y and δ satisfy 0<x1<1, 0<y1<1 and 0≤δ≤1, respectively.

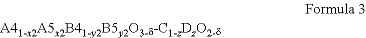

wherein
A4 includes La, Ba or Y,
A5 includes Sr or Ca,
B4 and B5 are different from each other and each include Mn, Co, Fe or Ni,
C includes Y, Sc, Gd, Sm or Ca,
D includes Zr or Ce, and
X2, y2, z and δ satisfy 0<x2<1, 0<y2<1, 0<z<1, and 0≤δ≤1, respectively.

In Formula 3, “-” may mean that A4₁₋ₓ₂A5ₓ₂B4_{1-y2}B5_{y}O_{3-δ} is doped with C_{1-z}D_{z}O_{2-δ}. Doping may mean that the two compounds are physically and chemically bonded.

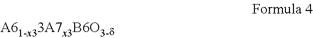

wherein
A6 includes La, Ba or Y,
A7 includes Sr or Ca,
B6 includes Mn, Co, Fe or Ni, and
x3 and δ satisfy 0<x3<1 and 0≤δ≤1, respectively.

The oxygen electrode carrier may, for example, be Laₙ₊₁NiₙO₃ₙ₊₁ (n=1, 2 or 3), La_{0.6}Sr_{0.4}Co_{0.2}Fe_{0.8}O_{3-δ} (0≤δ≤1), La_{0.6}Sr_{0.4}CoO_{3-δ} (0≤δ≤1) or the like.

The oxygen electrode catalyst may be supported by uniformly infiltrating the oxygen electrode catalyst into the internal pores of the oxygen electrode carrier.

The oxygen electrode catalyst may be free of impurities generated during the preparation process and have a perovskite single-phase structure.

The oxygen electrode catalyst may include a compound represented by Formula 5 below:

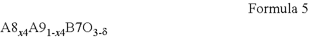

A8 and A9 are different from each other and include Sm, Sr, La, Ca or Ba,
B7 includes Co, Mn or Fe, and
X4 and 8 satisfy 0<x4<1 and 0≤δ≤1, respectively.

For example, the oxygen electrode catalyst may contain Sm_{0.5}Sr_{0.5}CoO₃.

The average diameter of the oxygen electrode catalyst may be 20 nm to 30 nm. The average diameter may be calculated by randomly extracting 200 particles from an electron microscopic image, measuring the diameter thereof, and averaging the measured diameters.

The fuel electrode 20 may include a fuel electrode carrier and a fuel electrode catalyst supported on the fuel electrode carrier.

FIG. 2 illustrates the configuration of a fuel electrode carrier according to the present disclosure. The fuel electrode carrier may include first particles containing nickel (Ni) and second particles containing yttria-stabilized zirconia (YSZ).

The first particles may be electronically conductive. The size of the first particles may be 1.5 μm or less. The size may mean a diameter. The lower limit of the size of the first particles is not particularly limited and may be 100 nm or more, 300 nm or more, 500 nm or more, or 700 nm or more.

The second particles may be oxygen-ion conductive. The size of the second particles may be 350 nm to 500 nm.

The fuel electrode carrier may contain a mixture of the first particles and the second particles.

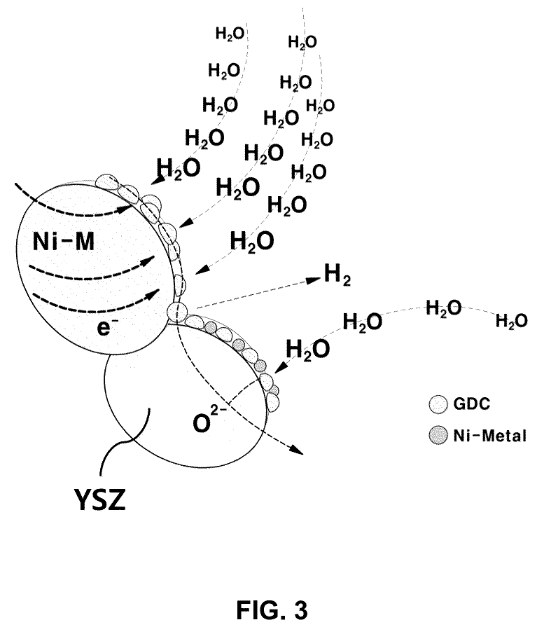

FIG. 3 illustrates the configuration of the fuel electrode according to the present disclosure.

The fuel electrode catalyst may contain a first component containing at least one selected from the group consisting of iron (Fe), cobalt (Co), palladium (Pd), copper (Cu), molybdenum (Mo), and a combination thereof, and a second component containing GDC (gadolinia-doped ceria).

The size of the fuel electrode catalyst may be 20 nm to 60 nm.

A part of the first component may form an alloy with the first particles on the surface of the first particles. The remaining part of the first component may be supported in the form of particles on the fuel electrode carrier.

A method of manufacturing a solid oxide electrolysis cell according to the present disclosure may include producing an oxygen electrode, producing a fuel electrode, and producing a stack including the oxygen electrode, the fuel electrode, and an electrolyte located between the oxygen electrode and the fuel electrode.

The producing the oxygen electrode includes dissolving a precursor of the oxygen electrode catalyst, urea and glycine in a solvent to prepare a reactant containing cations derived from the precursor of the oxygen electrode catalyst, adding the reactant to an oxygen electrode carrier including internal pores to obtain an intermediate, and heat-treating the intermediate to support the oxygen electrode catalyst in the internal pores of the oxygen electrode carrier.

The precursor of the oxygen electrode catalyst may include at least one selected from the group consisting of nitrate of the cation, acetate of the cation and combinations thereof.

The cation of the oxygen electrode catalyst may be a cation of an element containing at least one selected from the group consisting of Sm, Sr, La, Ca, Ba, Co, Mn, Fe, and combinations thereof.

Preferably, the precursor of the oxygen electrode catalyst may include samarium nitrate, samarium nitrate hexahydrate, strontium nitrate, cobalt nitrate, or cobalt nitrate hexahydrate. In addition, preferably, the cation derived from the precursor of the oxygen electrode catalyst may include samarium cations, strontium cations, and cobalt cations.

The urea may serve as a complexing agent when preparing reactants. As described later, when the intermediate is heated at a low temperature, urea is decomposed, and metal hydroxide and/or metal carbonate are precipitated, so that the catalyst can be uniformly supported in the internal pores of the oxygen electrode carrier.

Meanwhile, the urea may not serve as a complexing agent for strontium. Accordingly, the present disclosure is characterized in that an oxygen electrode catalyst having a single-phase perovskite structure is formed by adding glycine in combination with the urea to prevent the generation of impurities such as SrCO₃.

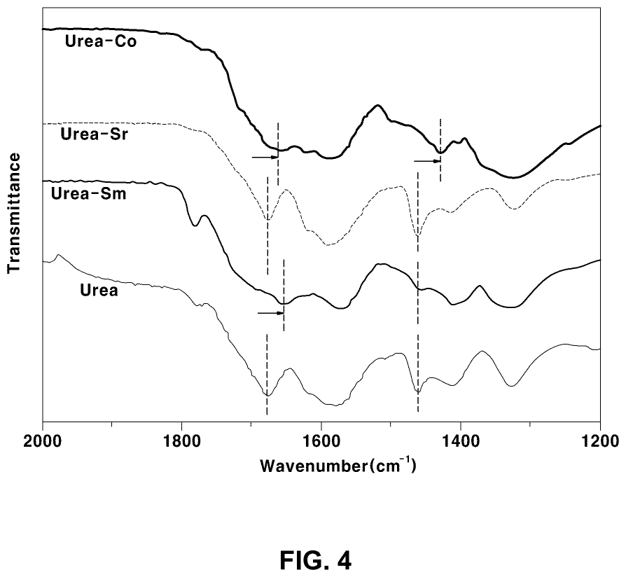

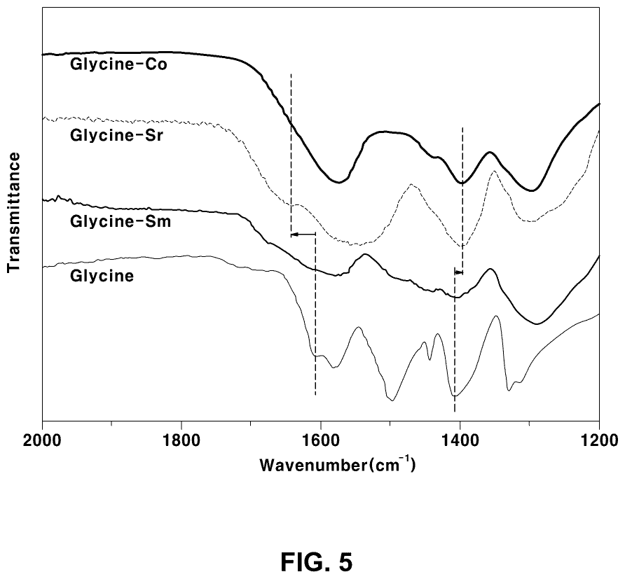

FIG. 4 illustrates the result of Fourier-transform infrared spectroscopy (FT-IR) when urea is bonded to metal cations. FIG. 5 illustrates the results of Fourier transform infrared spectroscopy analysis when glycine is bonded to metal cations. As can be seen from FIG. 4, there is no band shift of urea and strontium. This means that the bond between urea and strontium is weak and strontium is easily separated. This indicates that, when urea is used alone, the separated strontium may form impurities such as SrCO₃. As can be seen from FIG. 5, there is a clear band shift of glycine and strontium, which means that glycine is strongly bound to strontium. Therefore, a combination of glycine and urea can inhibit the separation of metal cations.

The reactant may include urea and cations at a molar ratio of 5:1 to 15:1. The reactant may include glycine and cations in a molar ratio of 0.5:1 to 5:1. When the molar ratios of urea and glycine fall within the range, the oxygen electrode catalyst may be formed without impurities by strongly bonding glycine or urea to cations derived from the precursor of the oxygen electrode catalyst.

The solvent may be water or a mixed solvent of water and alcohol. The mixed solvent may contain the alcohol and water in a volume ratio of 0.1:1 to 2:1.

The method of preparing the reactant is not particularly limited. For example, the precursor of the oxygen electrode catalyst, urea and glycine may first be dissolved in water, and then alcohol with low surface energy may be added thereto in the volume ratio, followed by mixing to prepare the reactant.

The oxygen electrode carrier may be heat-treated at 300° C. to 400° C. The oxygen electrode carrier may be heat treated to remove impurities from the internal pores. Accordingly, the reactant may be more smoothly injected into the oxygen electrode carrier.

The method of adding the reactant to the oxygen electrode carrier is not particularly limited. An intermediate may be obtained by impregnating the oxygen electrode carrier with a reactant, dropping the reactant onto the oxygen electrode carrier, or applying the reactant to the oxygen electrode carrier.

The amount of the reactant added is not particularly limited. The reactant may be added in an appropriate amount in consideration of the porosity, specific surface area, and amount of the desired catalyst supported on the oxygen electrode carrier.

The producing the oxygen electrode may further include heating the intermediate to 70° C. to 100° C. to decompose the urea before heat treating the intermediate. When the temperature during decomposition of urea is higher than 100° C., a drying effect occurs, the reactants move to the surface of the oxygen electrode carrier due to capillary force, and the oxygen electrode catalyst may not be properly supported in the internal pores of the oxygen electrode carrier.

The step of supporting the oxygen electrode catalyst may include heat treating the intermediate at 60° C. to 700° C. When the intermediate is heat treated, the catalyst precipitated or attached to the internal pores of the oxygen electrode carrier is crystallized, thus forming a stronger bond between the oxygen electrode catalyst and the oxygen electrode carrier.

The producing the fuel electrode includes preparing a fuel electrode carrier including the first particles and the second particles, adding, to the fuel electrode carrier, a first solution containing a precursor of the first component, a complexing agent, and a mixed solvent of an aqueous solvent and an alcohol-based solvent, and performing primary heat treatment to obtain a first intermediate, adding, to the first intermediate, a second solution containing a precursor of the second component, a complexing agent, and a mixed solvent of an aqueous solvent and an alcohol-based solvent, and performing secondary heat treatment to obtain a second intermediate, and reducing the second intermediate under a hydrogen atmosphere to the fuel electrode.

The method of preparing the fuel electrode carrier is not particularly limited, and may be prepared by a conventionally known method. For example, the fuel electrode carrier may be prepared by spray-drying a mixture of nickel oxide (NiO), YSZ, and a solvent to obtain a powder, pressurizing or slurrying the powder, and tape casting.

The preparation method according to the present disclosure may further include heat treating the fuel electrode carrier before adding the precursor of the first component to the fuel electrode carrier. For example, the fuel electrode carrier may be heat treated at about 300° C. to 500° C.

The first solution containing a precursor of the first component, a complexing agent, and a mixed solvent of an aqueous solvent and an alcohol-based solvent may be added to the fuel electrode carrier to infiltrate the precursor of the first component into the pores of the fuel electrode carrier.

The first component is a component of the fuel electrode catalyst and may include at least one selected from the group consisting of iron (Fe), cobalt (Co), palladium (Pd), copper (Cu), molybdenum (Mo), and combinations thereof.

The precursor of the first component may include a nitrate, an acetic compound, or a chloride compound of the first component.

The amount of the precursor of the first component may be 2.25 mg/cm² to 2.75 mg/cm².

The complexing agent may include at least one selected from the group consisting of urea, glycine, Triton-X, citric acid, and combinations thereof.

The amount of the complexing agent added is not particularly limited, and for example, may be an amount to adjust the molar ratio of the cation of the precursor of the first component to the complexing agent in the first solution to 1 to 10.

The mixed solvent may contain the aqueous solvent and the alcohol-based solvent in a volume ratio of 1:1 to 1:3.

The first solution may be prepared by dissolving the precursor of the first component in an aqueous solvent, adding a complexing agent thereto, and adding an alcohol-based solvent thereto.

After the first solution is added to the fuel electrode carrier, the resulting product is subjected to primary heat treatment to obtain a first intermediate in which the oxide of the first component is supported on the fuel electrode carrier.

The primary heat treatment includes heating the resulting product at 50° C. to 100° C. for 1 hour to 3 hours, heating the resulting product at 120° C. to 200° C. for 1 hour to 2 hours, and heating the resulting product at 300° C. to 500° C. for 1 hour to 3 hours.

The primary heat treatment may be repeated one or more times.

When the first solution is added to the fuel electrode carrier to infiltrate the precursor of the first component into the pores of the fuel electrode carrier, the resulting product is heated to 50° C. to 100° C., the complexing agent is decomposed and thus the precursor of the first component is precipitated on the fuel electrode carrier. Then, when the temperature is increased to 120° C. to 200° C. and then to 300° C. to 500° C., the precursor of the first component is supported in the form of an oxide on the fuel electrode carrier.

A second solution containing a precursor of the second component, a complexing agent, and a mixed solvent of an aqueous solvent and an alcohol-based solvent may be added to the first intermediate to infiltrate the precursor of the second component into the pores of the fuel electrode carrier.

The precursor of the second component may contain a nitrate of gadolinium (Gd), a nitrate of cerium (Ce), an acetic compound, or a chloride compound.

The amount of the precursor of the second component may be 81 mg/cm² to 87 mg/cm².

The complexing agent may include at least one selected from the group consisting of urea, glycine, Triton-X, citric acid, and combinations thereof.

The amount of the complexing agent added is not particularly limited, and for example, may be an amount to adjust the molar ratio of the cation of the precursor of the second component to the complexing agent in the second solution to 1 to 10.

The mixed solvent may contain the aqueous solvent and the alcohol-based solvent in a volume ratio of 1:1 to 1:3.

The second solution may be prepared by dissolving the precursor of the second component in an aqueous solvent, adding a complexing agent thereto, and adding an alcohol-based solvent thereto.

After the second solution is added to the fuel electrode carrier, the resulting product is subjected to secondary heat treatment to obtain a second intermediate in which the oxide of the first component and the second component are supported on the fuel electrode carrier.

The secondary heat treatment includes heating the resulting product at 50° C. to 100° C. for 1 hour to 3 hours, heating the resulting product at 120° C. to 200° C. for 1 hour to 2 hours, and heating the resulting product at 300° C. to 500° C. for 1 hour to 3 hours.

The secondary heat treatment may be repeated one or more times.

When the second solution is added to the fuel electrode carrier to infiltrate the precursor of the second component into the pores of the fuel electrode carrier, and then the resulting product is heated to 50° C. to 100° C., the complexing agent is decomposed and thus the precursor of the second component is precipitated on the fuel electrode carrier. Then, when the temperature is increased to 120° C. to 200° C. and then to 300° C. to 500° C., the second component is supported on the fuel electrode carrier.

Then, the second intermediate may be reduced under a hydrogen atmosphere at a temperature of 750° C. to 800° C. to obtain a fuel electrode.

The hydrogen atmosphere may contain about 3% by volume of water vapor and about 97% of hydrogen gas.

A part of the first component may form an alloy with the first particles on the surface of the first particles. The remaining part of the first component may be supported in the form of particles on the fuel electrode carrier.

When the second intermediate is heat treated under a hydrogen atmosphere, nickel oxide (NiO) is reduced to nickel (Ni), the oxide of the first component is reduced to the first component, and the nickel (Ni) and the first component form an alloy.

The present disclosure is characterized in that the precursor of the first component is first infiltrated into and supported on the carrier, and then the precursor of the second component is added thereto. When the precursor of the second component is first added, alloying of the first component with the first particles may not occur smoothly. The fuel electrode according to the present disclosure has a configuration in which the first particles are alloyed with the first component and includes many GDC reaction points and thus low electrode resistance and high water electrolysis efficiency.

The method of manufacturing the stack is not particularly limited. The oxygen electrode, the fuel electrode, and the electrolyte may be produced and stacked separately, or the oxygen electrode, fuel electrode, electrolyte, or precursors thereof may be stacked and post- processing may be performed to form a stack. In addition, the production order of the oxygen electrode, fuel electrode, and electrolyte is not particularly limited.

Hereinafter, the present disclosure will be described in more detail with reference to the following examples and the like. However, these examples should not be construed as limiting the scope of the present disclosure. It would be obvious that the present disclosure for which no specific experimental results are presented can be implemented by those skilled in the art based on the disclosure of the present disclosure including the following examples.

### Preparation Example 1

As precursors for the oxygen electrode catalyst, samarium nitrate hydrate (Sm(NO₃)₃·6H₂O), strontium nitrate (Sr(NO₃)₂), and cobalt nitrate hydrate (Co(NO₃)₂·6H₂O) were weighed depending on the composition of Sm_{0.5}Sr_{0.5}CoO₃.

The precursor of the oxygen electrode catalyst was dissolved in water, and urea and glycine were added to the resulting solution. The molar ratio of the urea and cations derived from the precursor of the oxygen electrode catalyst was 10:1. The molar ratio between the glycine and the cation derived from the precursor of the oxygen electrode catalyst was 1:1. Then, ethanol was added thereto, followed by mixing to prepare a reactant. The volume ratio of water to ethanol was adjusted to 55:45.

The reactant was heated at about 80° C. for about 1 hour, and the resulting product was heat-treated at about 650° C. for about 2 hours to obtain an oxygen electrode catalyst as a powder.

### Comparative Preparation Example 1

An oxygen electrode catalyst was prepared as a powder in the same manner as in Preparation Example 1, except that glycine was not added.

### Comparative Preparation Example 2

An oxygen electrode catalyst was prepared as a powder in the same manner as in Preparation Example 1, except that the molar ratio of urea to cations derived from the catalyst precursor was adjusted to 1:1.

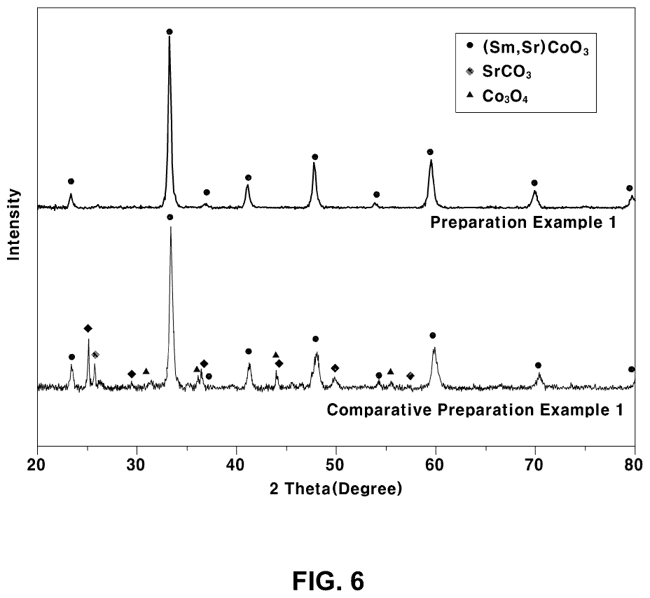

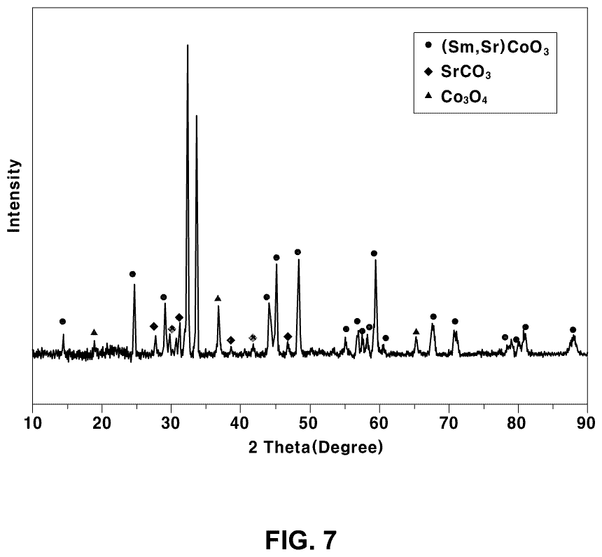

FIG. 6 shows the results of X-ray diffraction (XRD) analysis of the oxygen electrode catalysts according to Preparation Example 1 and Comparative Preparation Example 1. FIG. 7 shows the results of X-ray diffraction analysis of the oxygen electrode catalyst according to Comparative Preparation Example 2. Referring to this, a single-phase perovskite structure is found in the oxygen electrode catalyst according to Preparation Example 1, whereas peaks due to impurities such as SrCO₃ and Co₃O₄ are found in Comparative Preparation Examples 1 and 2.

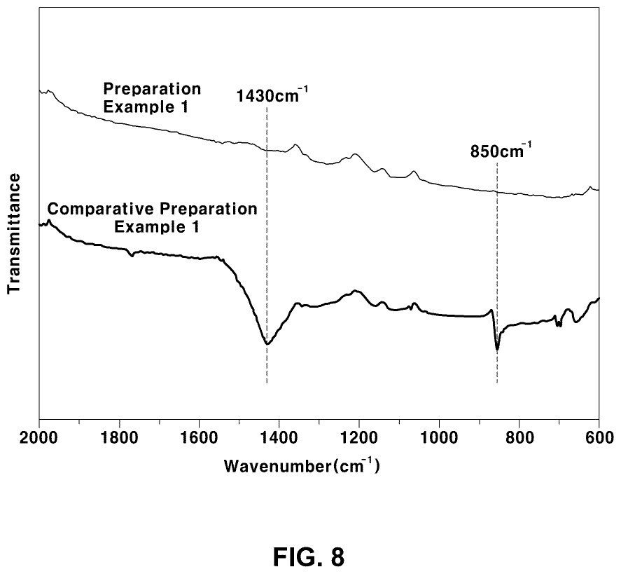

FIG. 8 shows the results of Fourier transform infrared spectroscopy analysis of the oxygen electrode catalysts according to Preparation Example 1 and Comparative Preparation Example 1. Strong peaks related to the SrCO₃ phase are found at 1,430 cm⁻¹ and 850 cm⁻¹ in Comparative Preparation Example 1, whereas the corresponding peaks are not found in Preparation Example 1.

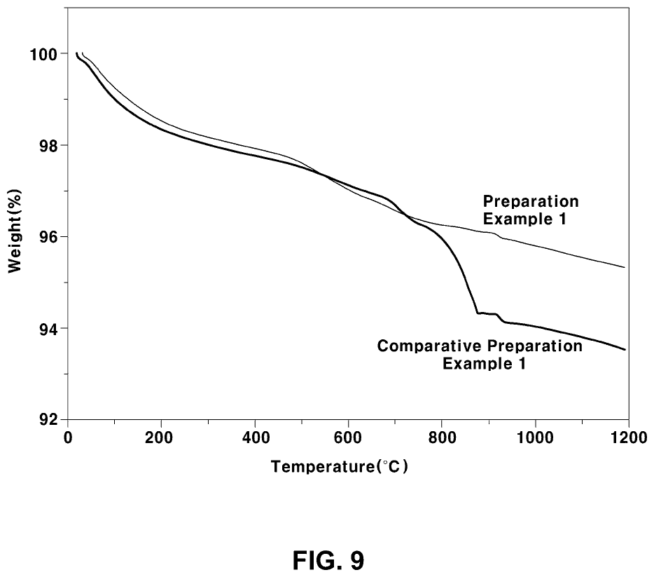

FIG. 9 shows the results of thermogravimetric analysis (TGA) for the oxygen electrode catalysts according to Preparation Example 1 and Comparative Preparation Example 1. Preparation Example 1 exhibits a gradual weight loss up to 1,200° C., whereas Comparative Preparation Example 1 exhibits a sharp weight loss due to thermal decomposition of the SrCO₃ phase at 800° C. to 1,000° C.

This indicates that, when urea and glycine are used in an appropriate ratio as in the present disclosure, a single-phase fuel electrode catalyst can be produced without impurities.

### Example 1

As precursors for the oxygen electrode catalyst, samarium nitrate hydrate (Sm(NO₃)₃·6H₂O), strontium nitrate (Sr(NO₃)₂), and cobalt nitrate hydrate (Co(NO₃)₂·6H₂O) were weighed according to the composition of Sm_{0.5}Sr_{0.5}CoO₃.

The precursor of the oxygen electrode catalyst was dissolved in water, and urea and glycine were added to the resulting solution. The molar ratio of the urea and cations derived from the precursor of the oxygen electrode catalyst was 10:1. The molar ratio between the glycine and the cation derived from the precursor of the oxygen electrode catalyst was 1:1. Then, ethanol was added thereto, followed by mixing, to prepare a reactant. The volume ratio of water to ethanol was adjusted to 55:45.

A plate-shaped electrolyte containing gadolinium doped ceria (GDC) and having a thickness of about 2 mm was prepared. An oxygen electrode carrier was formed on both surfaces of the electrolyte. The oxygen electrode carrier includes a functional layer containing LSCF-GDC and being attached to the electrolyte, and a current collector located on the functional layer and containing LSCF.

The reactant was added to the oxygen electrode carrier and then heated at about 80° C. for about 1 hour to obtain an intermediate. The intermediate was heat-treated at about 650° C. for about 2 hours to obtain a solid oxide electrolysis cell having a symmetrical cell structure in which the oxygen electrode was formed on both surfaces of the electrolyte.

### Comparative Example 1

A solid oxide electrolysis cell was produced in the same manner as in Example 1, except that glycine was not added.

### Comparative Example 2

A solid oxide electrolysis cell having a stack structure of support layer-electrolyte-support layer in which no reactant was added in Example 1 was set as Comparative Example 2.

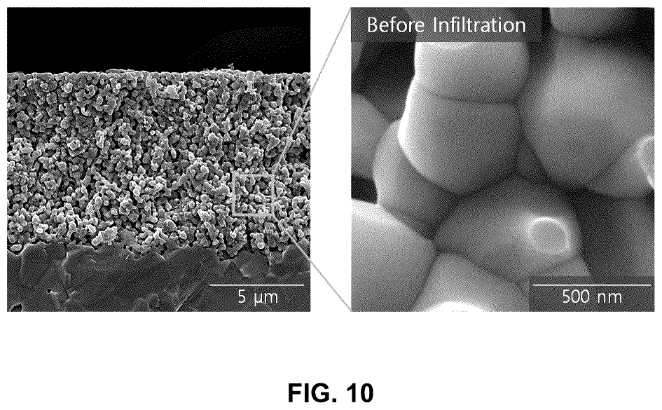

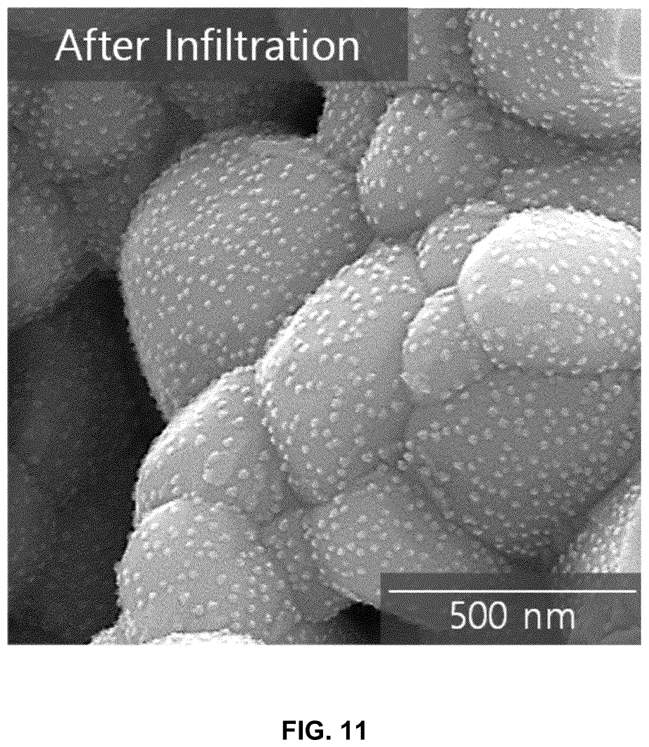

FIG. 10 shows the results of scanning electron microscope (SEM) analysis of the oxygen electrode for a solid oxide electrolysis cell according to Comparative Example 2. FIG. 11 shows the results of scanning electron microscopy analysis of the oxygen electrode for a solid oxide electrolysis cell according to Example 1. As can be seen from FIG. 11, the oxygen electrode catalyst having an average diameter of about 20 nm to about 30 nm is very evenly supported in the internal pores of the oxygen electrode carrier.

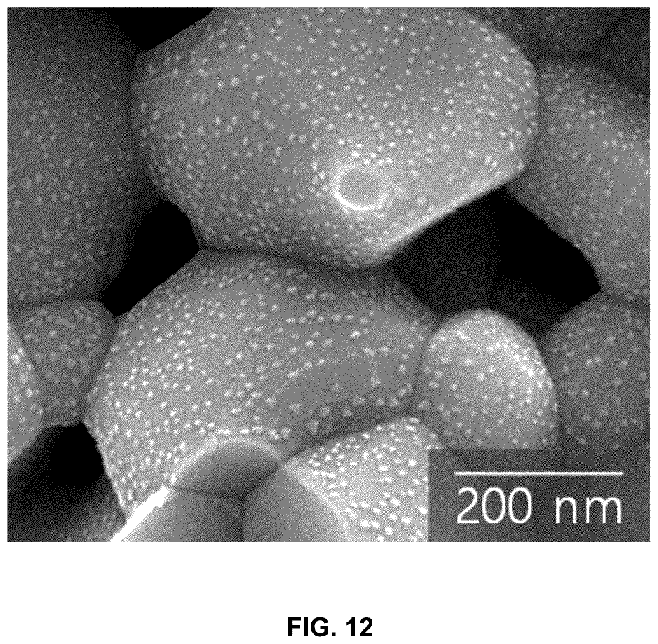

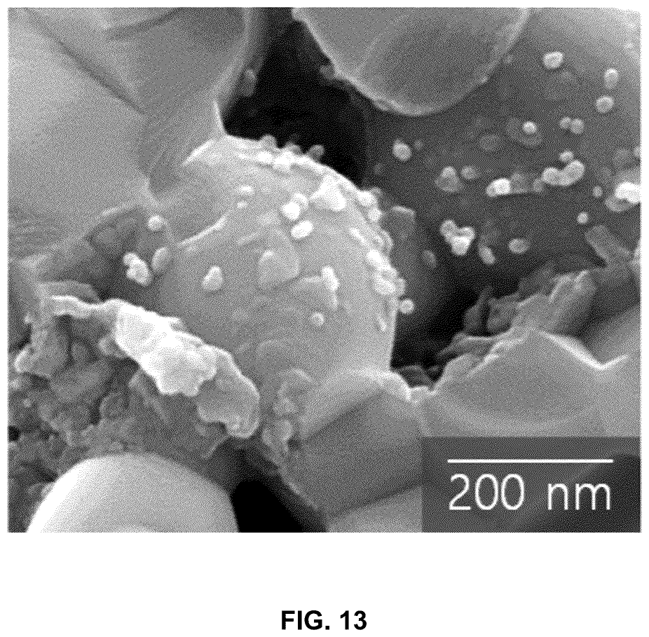

FIG. 12 shows the results of sintering the oxygen electrode for a solid oxide electrolysis cell according to Example 1 at about 650° C. for about 100 hours and analyzing the result using a scanning electron microscope. FIG. 13 illustrates the results of sintering the oxygen electrode for a solid oxide electrolysis cell according to Comparative Example 1 at about 650° C. for about 100 hours and analyzing the result using a scanning electron microscope. Referring to FIG. 13, the size of the oxygen electrode produced without using glycine grows to about 100 nm due to agglomeration of the oxygen electrode catalyst. On the other hand, as can be seen from FIG. 12, the shape of the oxygen electrode catalyst in the oxygen electrode according to Example 1 was not changed.

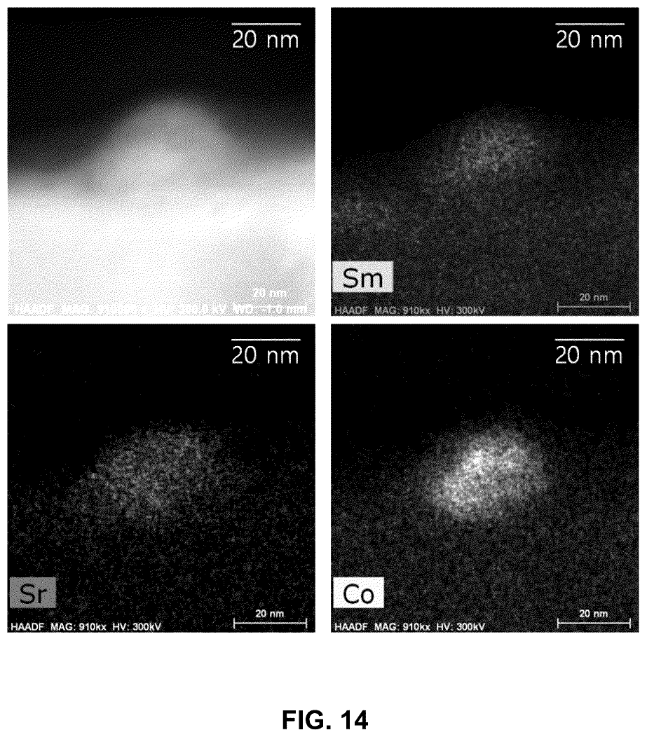

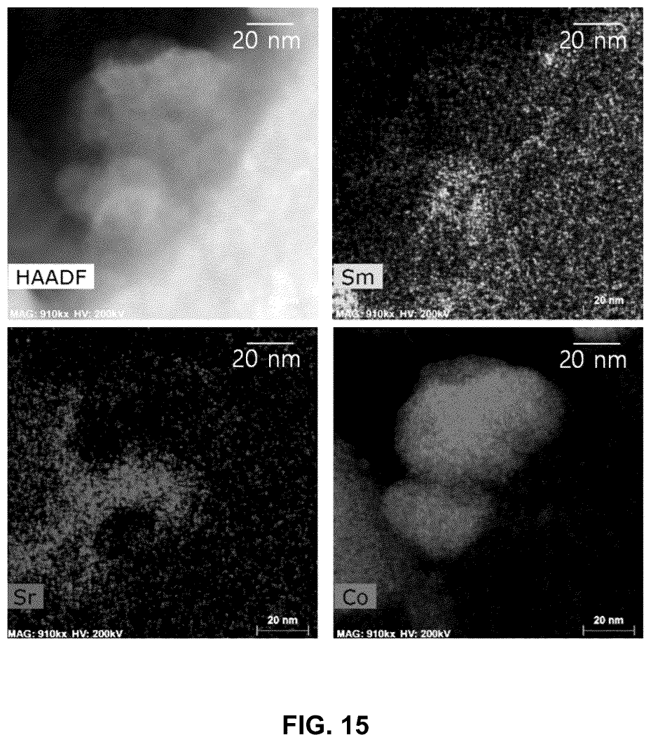

FIG. 14 illustrates the results of observing the oxygen electrode for a solid oxide electrolysis cell according to Example 1 using a transmission electron microscope. FIG. 15 illustrates the results of observing the oxygen electrode for a solid oxide electrolysis cell according to Comparative Example 1 using a transmission electron microscope. As can be seen from these drawings, in Example 1, samarium, strontium, and cobalt exist uniformly, whereas, in Comparative Example 1, the elements are separated from each other and have a different form.

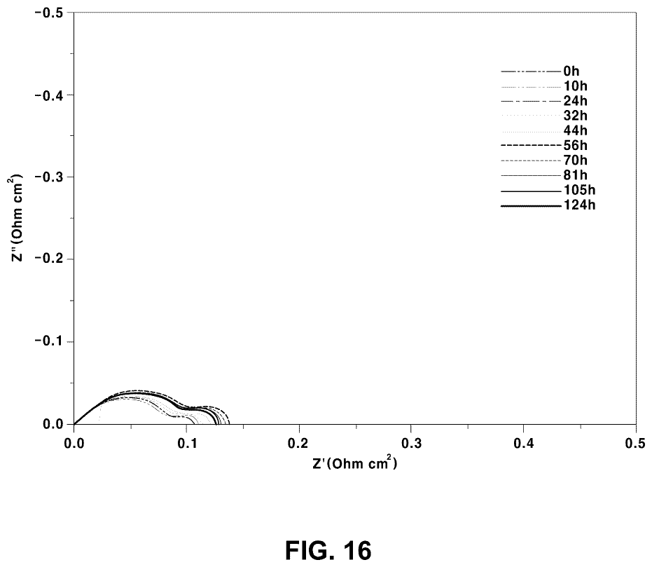

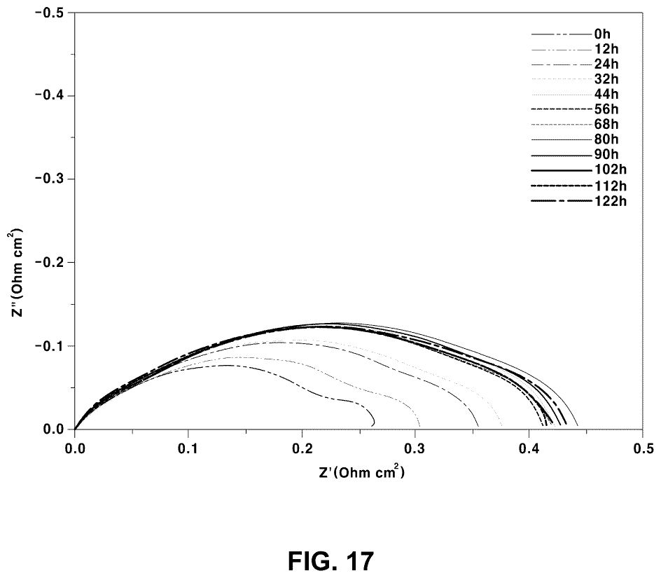

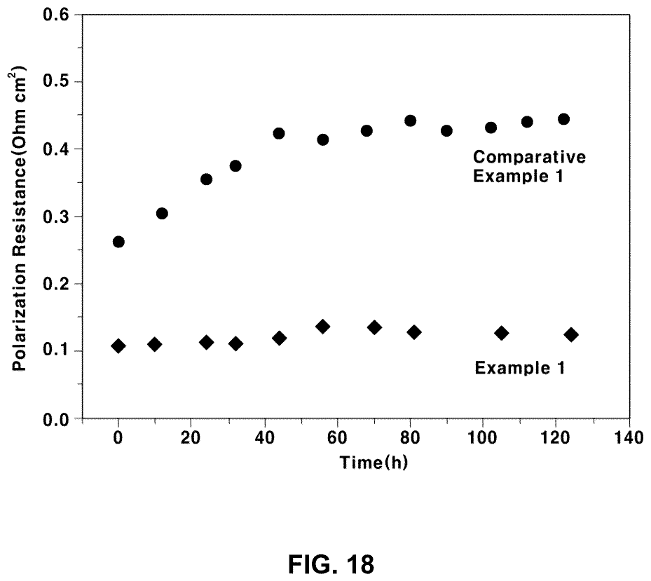

FIG. 16 illustrates the results of measuring the electrochemical performance of the solid oxide electrolysis cell according to Example 1. FIG. 17 illustrates the results of measuring the electrochemical performance of the solid oxide electrolysis cell according to Comparative Example 1. The electrochemical performance of each cell was measured using a Solartron 1260/1287. FIG. 18 illustrates the polarization resistance of the solid oxide electrolysis cells according to Example 1 and Comparative Example 1. As can be seen from these drawings, the resistance of Example 1 was greatly reduced compared to Comparative Example 1.

### Example 2

A solid oxide electrolysis cell was manufactured in the same manner as in Example 1, except that LSC was used as the oxygen electrode.

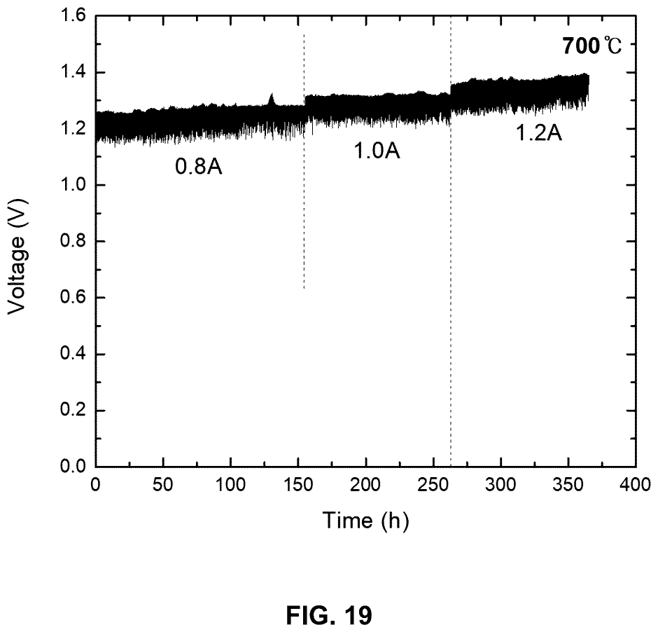

FIG. 19 illustrates the measurement of the deterioration rate of the solid oxide electrolysis cell according to Example 2. The cell was tested at 0.8 A/cm² for 155 hours, at 1.0 A/cm² for 108 hours, and at 1.2 A/cm² for 100 hours. The test environment was approximately 700° C. and the volume ratio of hydrogen to water vapor was 1:1. With reference to this, the cell operates very stably. Specifically, the cell has a deterioration rate of about 8.7%, calculated from the difference between the initial and final voltages at a current density of 0.8 A/cm², and a deterioration rate of about 9.2%, calculated from the difference between the initial and final voltages at a current density of 1.0 A/cm², which means that there is almost no performance deterioration therebetween.

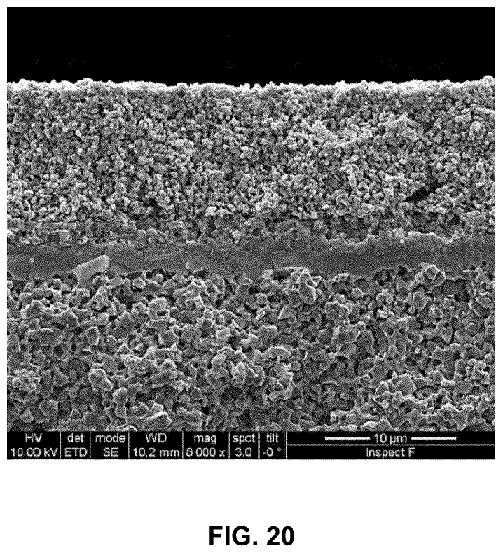

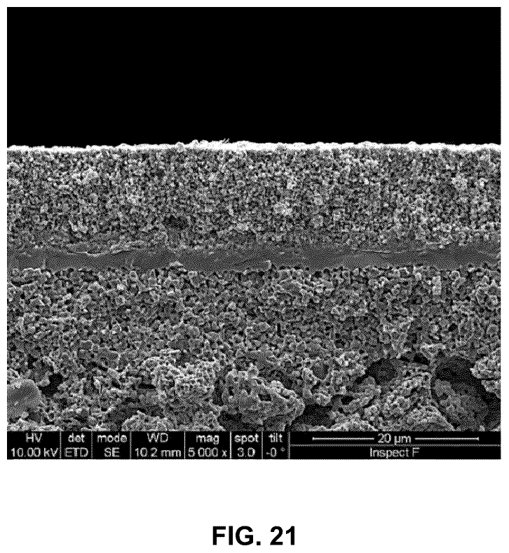

FIG. 20 illustrates the results of analyzing the solid oxide electrolysis cell according to Example 2 using a scanning electron microscope before evaluating the deterioration rate. FIG. 21 illustrates the results of analyzing the solid oxide electrolysis cell according to Example 2 using a scanning electron microscope after evaluating the deterioration rate. As can be seen from these drawings, Example 2 did not peel off the oxygen electrode even after operation for about 360 hours.

### Preparation Example 2

A fuel electrode carrier in which nickel oxide and YSZ were evenly dispersed was prepared.

The first solution was prepared as follows. Fe(NO₃)₃·9H₂O was diluted in distilled water and then urea was added such that the molar ratio of cations thereof to urea was adjusted to 1:10. Ethanol was added thereto so that the volume ratio of distilled water and ethanol was 1:3 to obtain the first solution.

The second solution was prepared as follows. Ce(NO₃)₂·6H₂O and Gd(NO₃)₃·6H₂O were diluted in distilled water such that the molar ratio of cerium (Ce) and gadolinium (Gd) in distilled water was 7:3 and the molar ratio of cations thereof to urea was adjusted to 1:10. Ethanol was added thereto so that the volume ratio of distilled water to ethanol was 1:3 to obtain the second solution.

First, the fuel electrode carrier was pre-heat treated at about 400° C.

After pre-heat treatment, the carrier was sufficiently cooled, the first solution was dropped onto the fuel electrode carrier using a micropipette and infiltrated into the fuel electrode carrier, and then primary heat treatment was performed while maintaining the result at 80° C. for 2 hours, at 150° C. for 1 hour, and at 400° C. for 2 hours. The primary heat treatment was performed once.

The first intermediate obtained by primary heat treatment was sufficiently cooled, the second solution was dropped onto the fuel electrode carrier using a micropipette and infiltrated into the fuel electrode carrier, and then secondary heat treatment was performed while maintaining the result at 80° C. for 2 hours, at 150° C. for 1 hour, and at 400° C. for 2 hours. The secondary heat treatment was performed three times.

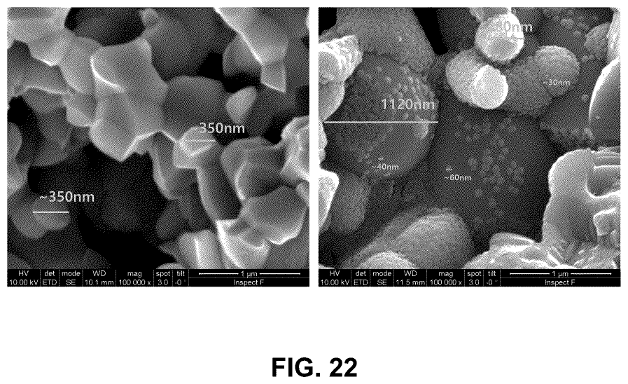

The second intermediate obtained through the secondary heat treatment was reduced at 800° C. under a hydrogen atmosphere to obtain a fuel electrode. FIG. 22 illustrates the results of analyzing the fuel electrode according to Preparation Example 2 using a scanning electron microscope (SEM). It can be seen that a catalyst with a size of 20 nm to 60 nm is supported on first particles (Ni) with a size of 1.5 um or less and second particles (YSZ) with a size of 350 nm to 500 nm.

### Preparation Example 3

A fuel electrode was produced in the same manner as in Preparation Example 2, except that cobalt nitrate was used as a precursor for the first component.

### Comparative Preparation Example 3

The carrier into which the first and second solutions were infiltrated was set as Comparative Preparation Example 3.

### Comparative Preparation Example 4

A fuel electrode was produced in the same manner as in Preparation Example 2, except that only the second solution was added without adding the first solution.

### Comparative Preparation Example 5

A fuel electrode was produced in the same manner as in Preparation Example 2, except that the order was changed, in other words, the second solution was first added and then the first solution was added thereto.

### Comparative Preparation Example 6

A fuel electrode was produced in the same manner as in Preparation Example 2, except that only the first solution was added without adding the second solution.

Hereinafter, Preparation Example 2 refers to “Fe-GDC”, Preparation Example 3 refers to “Co-GDC”, Comparative Preparation Example 3 refers to “reference”, Preparation Example 4 refers to “GDC”, Preparation Example 5 refers to “GDC-Fe”, and Comparative Preparation Example 6 refers to “Fe”.

### Experimental Example 1

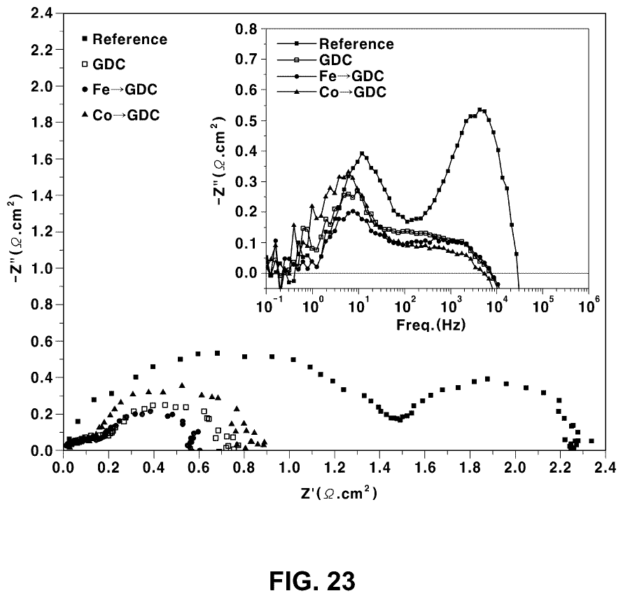

Polarization resistance of Preparation Example 2 (Fe-GDC), Preparation Example 3 (Co-GDC), Comparative Preparation Example 3 (Reference), and Comparative Preparation Example 4 (GDC) were measured. The results are as shown in FIG. 23. As can be seen from FIG. 23, the polarization resistance of the fuel electrode of Preparation Example 2 is the lowest.

The polarization resistance of Preparation Example 2 (Fe-GDC), Comparative Preparation Example 3 (Reference), Comparative Preparation Example 4 (GDC), and Comparative Preparation Example 5 (GDC-Fe) was measured and the result is shown in Table 1 below.

TABLE 1

| | Polarization |
|---|---|
| Item | resistance @700° C. |
| Comparative Preparation | 1.50 |
| Example 3 (Reference) | |
| Comparative Preparation | 0.71 |
| Example 4 (GDC) | |
| Comparative Preparation | 0.92 |
| Example 5 (GDC-Fe) | |
| Preparation Example 2 | 0.60 |
| (Fe-GDC) | |

Comparing Preparation Example 2 with Comparative Preparation Example 5, the polarization resistance of the fuel electrode of Preparation Example 2 is lower. That is, it can be seen that the first solution should be first infiltrated and then the second solution should be infiltrated, as in the present disclosure to reduce polarization resistance of the fuel electrode.

### Experimental Example 2

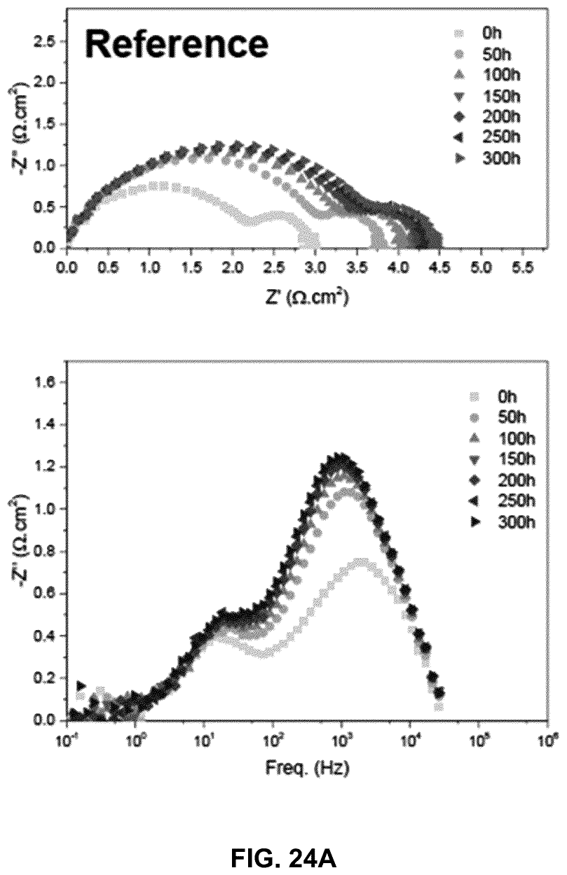

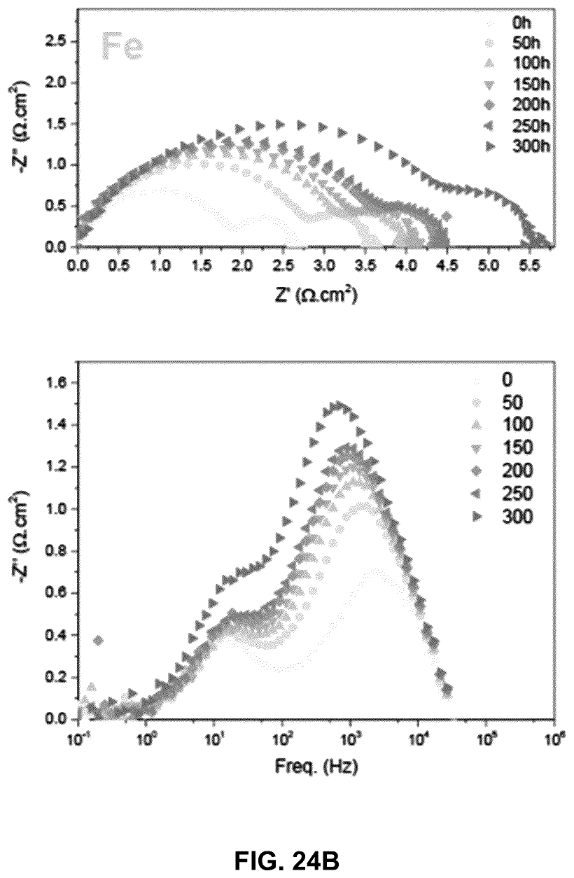

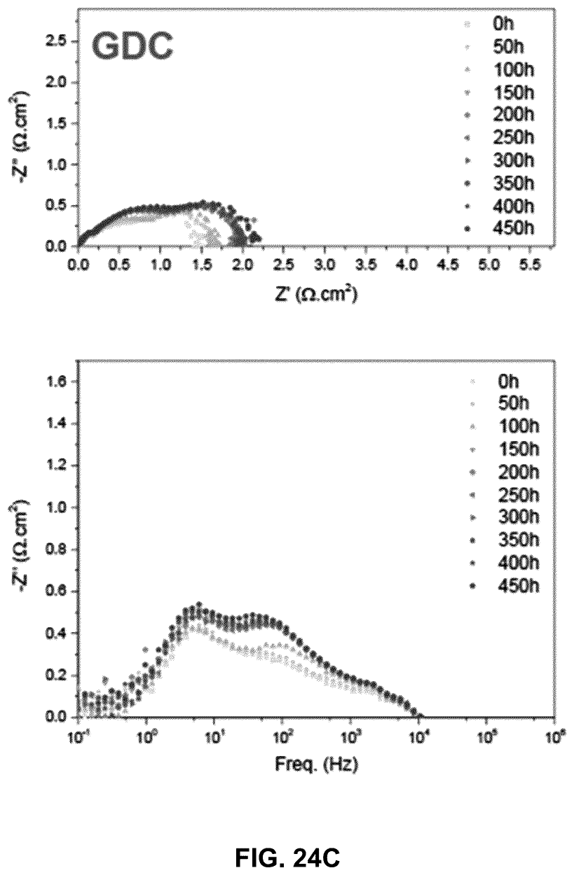

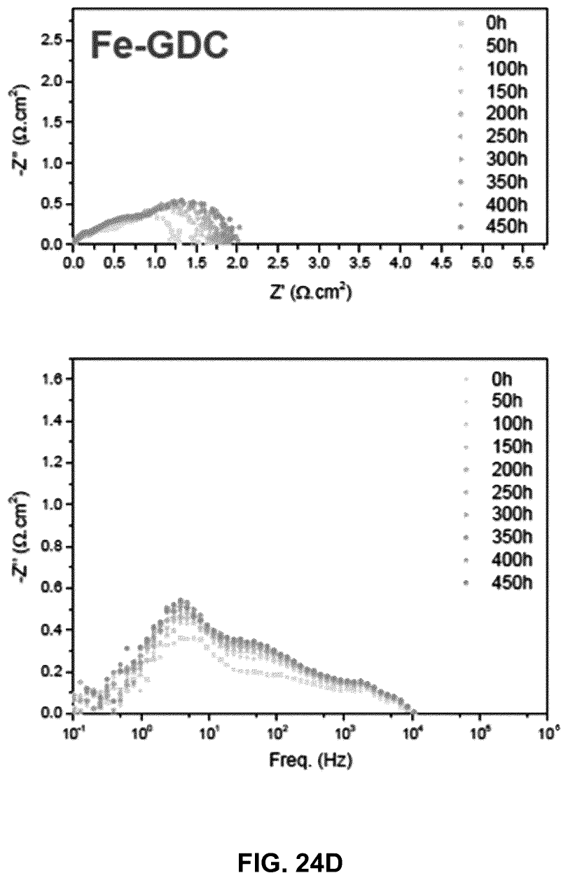

The durability of fuel electrodes according to Preparation Example 2 (Fe-GDC), Comparative Preparation Example 3 (Reference), Comparative Preparation Example 4 (GDC), and Comparative Preparation Example 6 (Fe) was measured and the result is shown in FIG. 24A to FIG. 24D below. As can be seen from FIG. 24A to FIG. 24D, the fuel electrode of Preparation Example 2 exhibits stability in the high frequency (103-104, charge transfer) region.

### Experimental Example 3

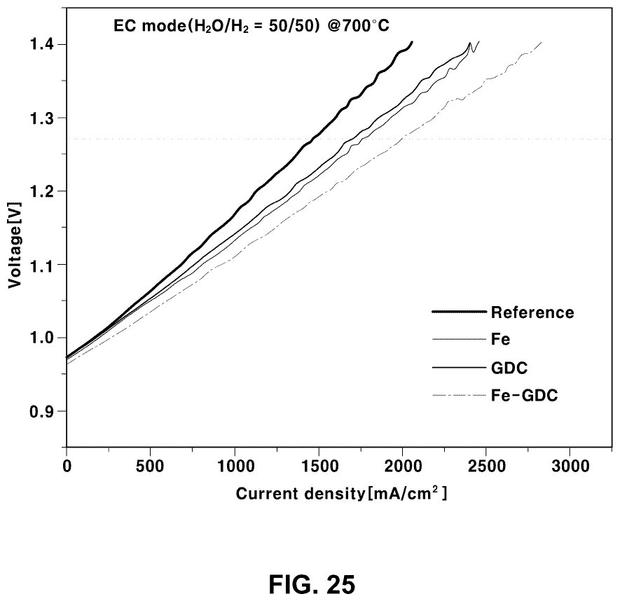

The performance of fuel electrodes according to Preparation Example 2 (Fe-GDC), Comparative Preparation Example 3 (Reference), Comparative Preparation Example 4 (GDC), and Comparative Preparation Example 6 (Fe) was measured and the result is shown in FIG. 25 below.

TABLE 2

| | Current density@1.3 V [A/cm²] | | | |
|---|---|---|---|---|
| | Comparative | Comparative | Comparative | |
| | Preparation | Preparation | Preparation | Preparation |
| Temperature | Example 3 | Example 6 | Example 4 | Example 2 |
| [° C.] | (Reference) | (Fe) | (GDC) | (Fe-GDC) |
| 800 | @1.2 V | @1.2 V | @1.2 V | @1.2 V |
| | 2.88 | 3.64 | 3.38 | 3.98 |
| 750 | 2.65 | 3.31 | 3.13 | 3.55 |
| 700 | 1.6 | 1.945 | 1.865 | 2.195 |
| 650 | 0.82 | 1.005 | 0.965 | 1.12 |

The fuel electrode according to Preparation Example 2 exhibits the highest current density at all voltages and temperatures. As the current density increases at the same voltage, the hydrogen production increases, which means that the hydrogen production efficiency of the fuel electrode according to the present disclosure is the highest.

As is apparent from the foregoing, the present disclosure provides a solid oxide electrolysis cell with high interfacial stability between the oxygen electrode and the electrolyte, and a method of manufacturing the same.

The present disclosure provides a solid oxide electrolysis cell with improved high-temperature water electrolysis efficiency and a method of manufacturing the same.

The present disclosure provides a solid oxide electrolysis cell with improved durability and a method of manufacturing the same.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

1. A solid oxide electrolysis cell comprising:
an oxygen electrode;
a fuel electrode; and
an electrolyte interposed between the oxygen electrode and the fuel electrode;
wherein the oxygen electrode comprises:
an oxygen electrode carrier comprising internal pores; and
an oxygen electrode catalyst supported in the internal pores, and having a perovskite single-phase structure;
wherein the fuel electrode comprises:
a fuel electrode carrier; and
a fuel electrode catalyst supported on the fuel electrode carrier;
wherein the fuel electrode carrier comprises:
a plurality of first particles comprising nickel (Ni); and
a plurality of second particles comprising yttria-stabilized zirconia (YSZ), wherein the fuel electrode catalyst comprises:
a first component comprising at least one selected from the group consisting of iron (Fe), cobalt (Co), palladium (Pd), copper (Cu), molybdenum (Mo), and combinations thereof; and
a second component comprising gadolinia-doped ceria (GDC);
wherein at least a part of the first component forms an alloy with the plurality of first particles on a surface of the plurality of first particles.

2. The solid oxide electrolysis cell according to claim 1, wherein the oxygen electrode carrier comprises at least one of compounds represented by: 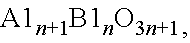
wherein A1 comprises La, Nd, Pr, or Ga,
B1 comprises Ni, Co, or Cu, and
n satisfies 1≤n≤3; 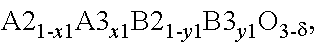
wherein
A2 comprises La, Ba or Y,
A3 comprises Sr or Ca,
B2 and B3 are different from each other and each comprise Mn, Co, Fe or Ni, and
x, y and δ satisfy 0<x1<1, 0<y1<1 and 0≤δ≤1, respectively; 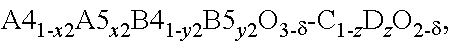
wherein
A4 comprises La, Ba or Y,
A5 comprises Sr or Ca,
B4 and B5 are different from each other and each comprise Mn, Co, Fe or Ni,
C comprises Y, Sc, Gd, Sm or Ca,
D comprises Zr or Ce, and
X2, y2, z and δ satisfy 0<x2<1, 0<y2<1, 0<z<1, and 0≤δ≤1, respectively; and 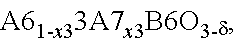
wherein
A6 comprises La, Ba or Y,
A7 comprises Sr or Ca,
B6 comprises Mn, Co, Fe or Ni, and
x3 and δ satisfy 0<x3<1 and 0≤δ≤1, respectively.

3. The solid oxide electrolysis cell according to claim 1, wherein the oxygen electrode carrier comprises a compound represented by: 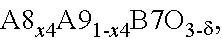
wherein A8 and A9 are different from each other and comprise Sm, Sr, La, Ca or Ba, respectively,
B7 comprises Co, Mn or Fe, and
X4 and δ satisfy 0<x4<1 and 0≤δ≤1, respectively.

4. The solid oxide electrolysis cell according to claim 1, wherein the oxygen electrode catalyst has an average diameter of 20 nm to 30 nm.

5. The solid oxide electrolysis cell according to claim 1, wherein the plurality of first particles have a size of 1.5 μm or less, and the second particles have a size of 350 nm to 500 nm.

6. The solid oxide electrolysis cell according to claim 1, wherein the fuel electrode catalyst has a size of 20 nm to 60 nm.

7. A method of manufacturing a solid oxide electrolysis cell comprising:
producing an oxygen electrode;
producing a fuel electrode; and
producing a stack comprising the oxygen electrode, the fuel electrode, and an electrolyte interposed between the oxygen electrode and the fuel electrode;
wherein the oxygen electrode comprises:
an oxygen electrode carrier comprising internal pores; and
an oxygen electrode catalyst supported in the internal pores, and having a perovskite single-phase structure;
wherein the fuel electrode comprises:
a fuel electrode carrier; and
a fuel electrode catalyst supported on the fuel electrode carrier;
wherein the fuel electrode carrier comprises:
a plurality of first particles comprising nickel (Ni); and
a plurality of second particles comprising yttria-stabilized zirconia (YSZ);
wherein the fuel electrode catalyst comprises:
a first component comprising at least one selected from the group consisting of iron (Fe), cobalt (Co), palladium (Pd), copper (Cu), molybdenum (Mo), and combinations thereof; and
a second component comprising gadolinia-doped ceria (GDC);
wherein at least a part of the first component forms an alloy with the plurality of first particles on a surface of the plurality of first particles.

8. The method according to claim 7, wherein the producing the oxygen electrode comprises:
dissolving a precursor of the oxygen electrode catalyst, urea, and glycine in a solvent to prepare a reactant comprising a cation derived from the precursor of the oxygen electrode catalyst;
adding the reactant to an oxygen electrode carrier to obtain an intermediate; and
heat-treating the intermediate to support the oxygen electrode catalyst in the internal pores of the oxygen electrode carrier.

9. The method according to claim 8, wherein the solvent comprises alcohol and water in a volume ratio of 0.1:1 to 2:1.

10. The method according to claim 8, wherein the cation derived from the precursor of the oxygen electrode catalyst comprises at least one selected from the group consisting of Sm, Sr, La, Ca, Ba, Co, Mn, Fe, and combinations thereof.

11. The method according to claim 8, wherein the reactant comprises the urea and the cation at a molar ratio of 5:1 to 15:1 and the reactant comprises the glycine and the cation at a molar ratio of 0.5:1 to 5:1.

12. The method according to claim 8, wherein the oxygen electrode carrier comprises at least one of compounds represented by: 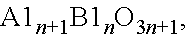
wherein A1 comprises La, Nd, Pr, or Ga,
B1 comprises Ni, Co, or Cu, and
n satisfies 1≤n≤3, 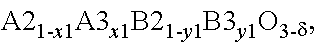
wherein
A2 comprises La, Ba or Y;
A3 comprises Sr or Ca;
B2 and B3 are different from each other and each comprise Mn, Co, Fe or Ni, and
x, y and δ satisfy 0<x1<1, 0<y1<1 and 0≤δ≤1, respectively, 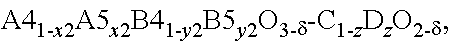
wherein
A4 comprises La, Ba or Y,
A5 comprises Sr or Ca,
B4 and B5 are different from each other and each comprise Mn, Co, Fe or Ni,
C comprises Y, Sc, Gd, Sm or Ca,
D comprises Zr or Ce, and
X2, y2, z and δ satisfy 0<x2<1, 0<y2<1, 0<z<1, and 0≤δ≤1, respectively, 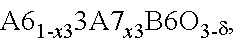
wherein
A6 comprises La, Ba or Y,
A7 comprises Sr or Ca,
B6 comprises Mn, Co, Fe or Ni, and
x3 and δ satisfy 0<x3<1 and 0≤δ≤1, respectively, and
the oxygen electrode catalyst comprises a compound represented by: 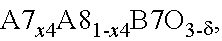
A7 and A8 are different from each other and comprise Sm, Sr, La, Ca or Ba,
B7 comprises Co, Mn or Fe, and
X4 and δ satisfy 0<x4<1 and 0≤δ≤1, respectively.

13. The method according to claim 7, wherein the producing the fuel electrode comprises:
preparing a fuel electrode carrier comprising the plurality of first particles and the plurality of second particles;
adding, to the fuel electrode carrier, a first solution comprising a precursor of the first component, a complexing agent, and a mixed solvent of an aqueous solvent and an alcohol-based solvent, and performing primary heat treatment to obtain a first intermediate;
adding, to the first intermediate, a second solution comprising a precursor of the second component, a complexing agent, and a mixed solvent of an aqueous solvent and an alcohol-based solvent, and performing secondary heat treatment to obtain a second intermediate; and
reducing the second intermediate under a hydrogen atmosphere to form a fuel electrode.

14. The method according to claim 13, wherein the plurality of first particles have a size of 1.5 μm or less and the plurality of second particles have a size of 350 nm to 500 nm.

15. The method according to claim 13, wherein a molar ratio of a cation of the precursor of the first component to the complexing agent in the first solution is 1 to 10 and a molar ratio of the cation of the precursor of the second component to the complexing agent in the second solution is 1 to 10.

16. The method according to claim 13, wherein the complexing agent comprises at least one selected from the group consisting of urea, glycine, Triton-X, citric acid, and combinations thereof.

17. The method according to claim 13, wherein the precursor of the first component is added in an amount of 2.25 mg/cm² to 2.75 mg/cm².

18. The method according to claim 13, wherein the primary heat treatment comprises heating the reaction product at 50° C. to 100° C. for 1 hour to 3 hours, heating the reaction product at 120° C. to 200° C. for 1 hour to 2 hours, and heating the reaction product at 300° C. to 500° C. for 1 hour to 3 hours, and
wherein the primary heat treatment is repeated one or more times.

19. The method according to claim 13, wherein the precursor of the second component is added in an amount of 81 mg/cm² to 87 mg/cm².

20. The method according to claim 13, wherein the secondary heat treatment comprises heating the reaction product at 50°° C. to 100° C. for 1 hour to 3 hours, heating the reaction product at 120° C. to 200° C. for 1 hour to 2 hours, and heating the reaction product at 300° C. to 500° C. for 1 hour to 3 hours, and
wherein the secondary heat treatment is repeated one or more times.
